(19) United States
(12) Patent Application Publication
(10) Pub. No.: US 2007/0145780 A1
(43) Pub. Date: Jun. 28, 2007

(54) Rotatable cab with multi-piece deck

(75) Inventors: Elizabeth S. Tecklenburg, Apex, NC (US); Robert M. Bower, Raleigh, NC (US); Matthew J. Harrenstein, Sanford, NC (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/315,286

(22) Filed: Dec. 23, 2005

(51) Int. Cl. B62D 33/06

(52) U.S. Cl. 296/190.08

(57) ABSTRACT

A machine cab includes a cab frame, side panels connected to the frame, a roof portion connected to the side panels, and a floor portion connected to the side panels. The floor portion includes a multi-piece floor.

### TECHNICAL FIELD

The present disclosure relates generally to a cab for a work machine, and more particularly, to a rotatable cab for a work machine

### BACKGROUND

Conventional skid steer loaders include a sheet metal floor to support the operator's seat and feet. Typically, the cab of the skid steer loader rotates upward to allow service personnel access to the machine to perform necessary maintenance and repairs. When the cab rotates, the floor, along with the seat mounted to the floor, remains with the body of the machine. Among other disadvantages, having a floor of this type limits the access of maintenance personnel to components within the machine body and causes difficulty in sealing the cab to provide efficient heating, ventilation, and air conditioning (HVAC), as well as appropriate noise reduction.

A fully-enclosed, rotatable machine cab provides certain advantages over conventional skid steer loaders. Fully enclosing the machine cab, however, may create problems during assembly. In particular, to assemble a fully-enclosed machine cab having a conventional floor, assembly personnel would have to enter the cab to attach interior cab components in place.

One method of providing access to a work machine's systems is described in Japanese Patent No. JP 10-121520 (the '520 patent) issued to Tadashi et al. The '520 patent describes a dividable floor plate for removal during inspection or repair of the machine body.

Although the system of the '520 patent may provide a dividable floor plate, it fails to provide maximum access to the work machine's systems by integrating the dividable cab floor to move with the machine cab during rotation. The disadvantages of this machine configuration include the fact that it limits the size of the machine door for operator ingress and egress, hampers sealing of the cab for heating, air conditioning, and ventilation (HVAC), and limits access of maintenance and service personnel to the machine body.

The disclosed system is directed to overcoming one or more of the problems set forth above.

### SUMMARY OF THE INVENTION

In one aspect, the present disclosure is directed to a machine cab, including a cab frame, side panels connected to the frame, a roof portion connected to the side panels, and a floor portion connected to the side panels. The floor portion includes a multi-piece floor.

In another aspect, the present disclosure is directed to a work machine including a work body, a work tool, a work arm assembly linking the work tool to the work body, and tilt cylinders disposed proximate the work tool and configured to orient the work tool. The work machine further includes a rotatably mounted, fully enclosed machine cab disposed adjacent the work body, the machine cab includes a multi-piece floor. The components of the multi-piece floor are configured to lock and seal together and to side panels and a cab frame when assembled.

In another aspect, the present disclosure is directed to a method of manufacturing a machine cab of a work machine, including providing a machine cab support frame, providing side panels, a roof portion, and a door portion, attaching the side panels and the roof portion to the support frame, and installing a multi-piece floor to the machine cab. The multi-piece floor is attached to the support frame and the side panels to form a fully enclosed machine cab.

### BRIEF DESCRIPTION OF THE DRAWINGS

FIG. 1 is a side view of a work machine with an exemplary disclosed machine cab construction;

FIG. 2 is a perspective cut-away view of the machine cab of FIG. 1;

FIG. 3 is an exploded view of an exemplary disclosed multi-piece floor for the machine cab of FIG. 1;

FIG. 4 is an assembled view of the multi-piece floor of FIG. 3;

FIG. 5 is a perspective view of a lock and seal feature of the assembled multi-piece floor of FIG. 4; and

FIG. 6 is a side view of the work machine of FIG. 1 with the machine cab rotated to an open position.

### DETAILED DESCRIPTION

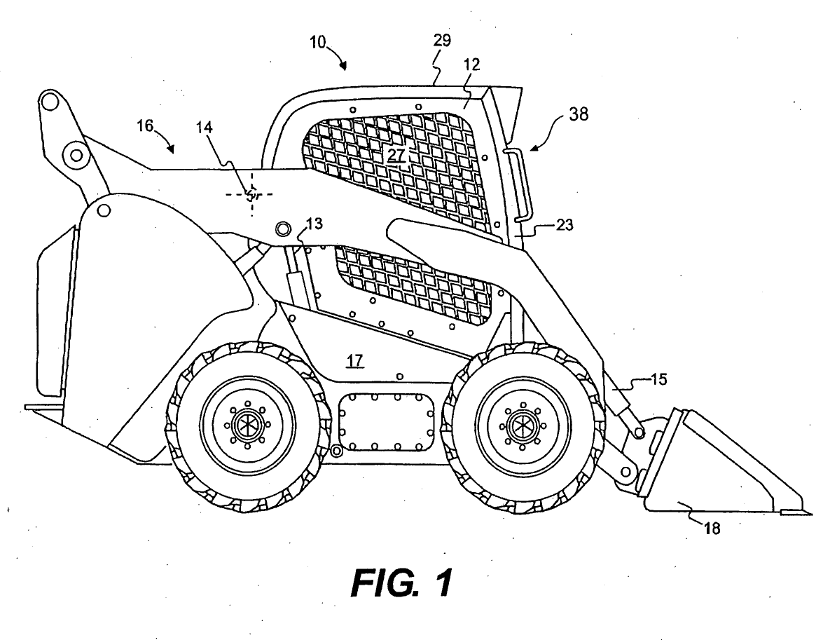

FIG. 1 illustrates an exemplary work machine 10 having multiple systems and components that cooperate to accomplish a task. Work machine 10 may embody a fixed or mobile machine that performs some type of operation associated with an industry such as mining, construction, farming, transportation, or any other industry known in the art. For example, work machine 10 may be an earth moving machine such as a skid steer loader, an excavator, a dozer, a loader, a backhoe loader, a motor grader, a dump truck, or any other earth moving machine. Work machine 10, shown as a skid steer loader in the figures, may include a fully enclosed rotatable machine cab 12 having side wall panels 27, cab lift cylinders 13, a cab pivot axis 14, tilt cylinders 15, a work arm assembly 16, a work body 17, and a work tool 18.

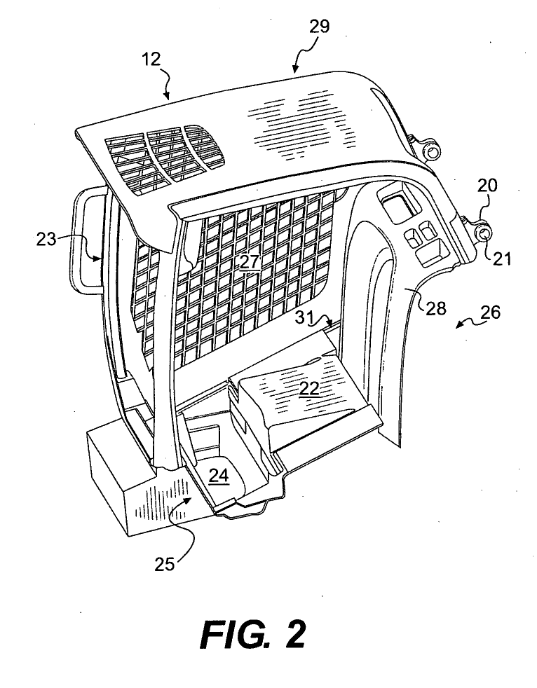

Referring to FIG. 2, an exemplary embodiment consistent with the disclosure includes a multi-piece floor 26, comprising a toe pan 24, a seat deck 22, and a rear wall portion 28. The fully enclosed rotatable machine cab 12 may include a support frame 23, side panels 27, a roof portion 29, and a front door 38. The front of the machine cab 12 terminates in the toe pan 24, which accommodates the operator's feet during operation. The rear wall portion 28 may include an HVAC box, storage box, radio mounts, electrical box, and the like, and may be made of non-metallic material.

The toe pan 24 extends forward of the remainder of the rotatable machine cab 12 and receives the operator's feet during operation of the work machine 10. The toe pan 24 does not extend across the entire width of the rotatable machine cab 12. Instead, the toe pan 24 terminates before reaching the outermost side edges of the rotatable machine cab 12 as denoted by the front corner spaced portions 25. As its name implies, the toe pan 24 is intended to cover the feet of the operator, and does not extend upward to enclose the operator's knees or legs.

To accommodate the required space for rotation, the machine cab's support frame 23 terminates above the floor portion 26 of the rotatable machine cab 12. The rotatable machine cab 12 is sculpted to include the two spaced portions 25, located beneath the support frame 23 to the sides of the toe pan 24. The spaced portions 25 allow the rotatable machine cab 12 to clear the tilt cylinders 15 during upward and rearward rotational movement.

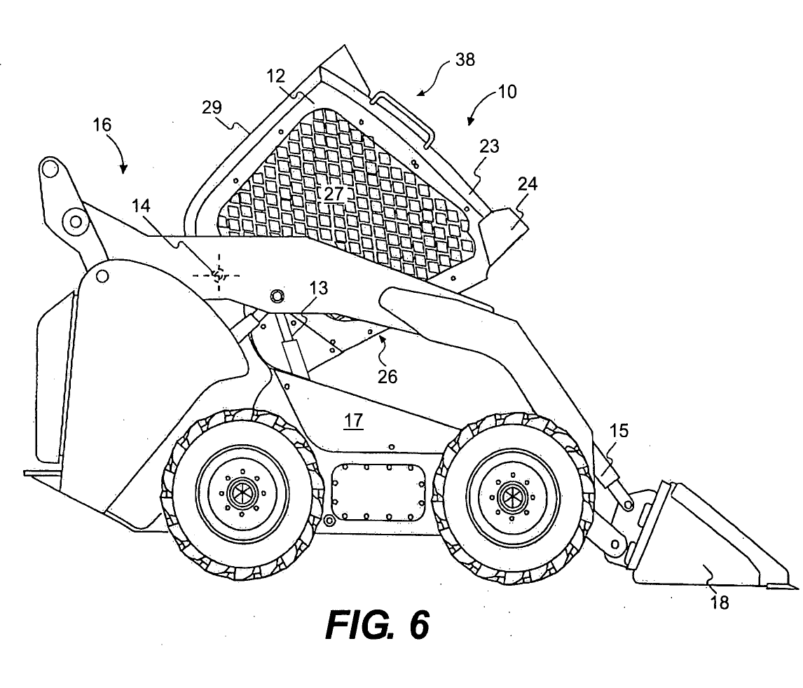

The rotatable machine cab 12 may include cab pivot mounts 20 on its exterior having a pivot bore 21. With the cab mounts 20 in this location, service personnel can more easily free the rotatable machine cab 12 for rearward rotational movement as shown in FIG. 6, thereby easing maintenance operations and access.

The toe pan 24 also houses the wash bottle (not shown), which holds windshield wiper fluid. Placing the wash bottle in the toe pan 24, instead of on the outside of the work machine 10, allows the operator easier access and enhanced visibility during operation of the work machine 10. Construction of the rotatable machine cab 12 may be of tubular steel for strength and/or formed of sheet metal and the like. The gussets in the corners of the rotatable machine cab 12 may include areas to mount lights or control panels (not shown).

The toe pan 24 accepts an operator's feet, the seat deck 22 supports the weight transferred from the operator's seat (not shown), and the rear wall portion 28 seals the back of the cab 12. Each of these components may be separately manufactured before assembly in the fully enclosed, rotatable machine cab 12.

Referring again to FIG. 2, during cab assembly, assemblers may add each of the floor components one at a time. For example, the assemblers may first install the toe pan 24, then the seat deck 22, and finally, the rear wall portion 28. All necessary assembly and finishing of the machine cab 12 may be completed before installing the multi-piece floor 26. Assembling the machine cab 12 in this manner may assist in cab assembly off of the machine work body 17. Moreover, adding the multi-piece floor 26 last or as a substantially final step allows for ingress and egress of welding robots and the like as well as assembly personnel during machine cab 12 and work body 17 assembly. After adding the components comprising the multi-piece floor 26, the entire machine cab 12 can be attached to the rest of the work machine 10.

The individual portions of the multi-piece floor 26 may include electrical controls (not shown) for the work machine 10. For example, the rear wall portion 28 may include controls for an optional radio and heating, ventilation, and air-conditioning system (not shown). These optional electrical controls may be added to the rear wall portion 28 before assembling the multi-piece floor 26 to the machine cab 12. Similarly, the seat that is mounted on the seat deck 22 may include electrical controls (not shown) for operating the work machine 10. If this is the case, the assembler can connect these controls with the remainder of the work machine 10 via a wire harness (not shown) when adding the fully-enclosed rotatable machine cab 12 to the work body 17.

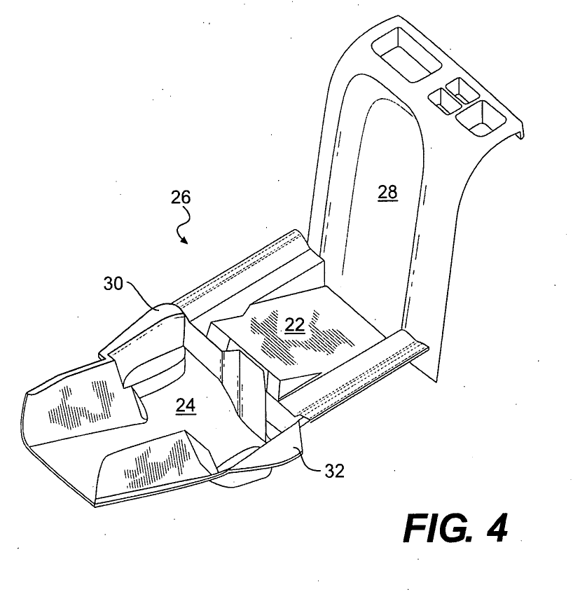

Referring to FIGS. 2-4, in at least some embodiments of the disclosure, at least one side portion of the multi-piece floor 26 may be slid into grooves or rails 31 defined along the side wall panels 27 of the fully-enclosed rotatable machine cab 12. For example, the toe pan 24 may include first and second side flanges 30, 32, respectively, which slide into grooves or rails 31, defined on the side wall panels 27 of the machine cab 12 during assembly. Similarly, seat deck 22 and rear wall portion 28 may include flanges configured to be received in grooves or rails 31. The side wall panels 27 may be securely attached to support frame 23 in any conventional manner. Rear wall portion 28 may also be similarly attached to the support frame 23 along a rearward edge. This approach securely seals the multi-piece floor 26 with the remainder of the machine cab 12 ensuring proper installation.

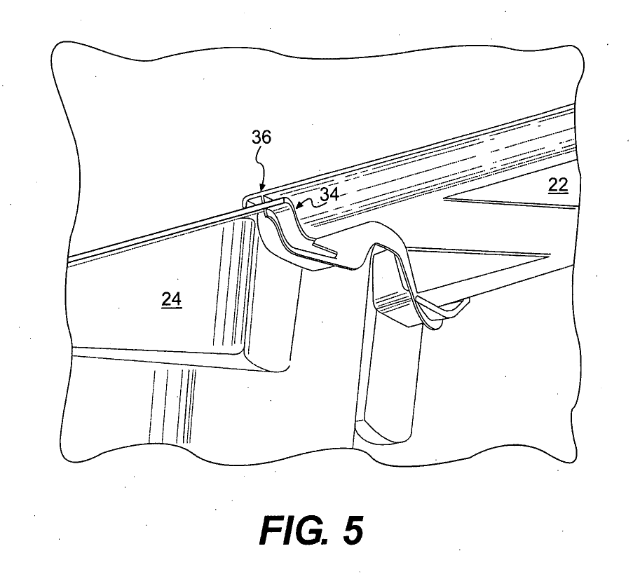

Referring to FIG. 5, two or more of the portions of the multi-piece floor 26 may mate together to ensure a proper seal. For example, the toe pan 24 may include an upper portion 34 which mates (locks and seals) with a front portion 36 of the seat deck 22. The locking may be achieved, for example, by a one-way wedged snap connection. Once snapped in place, these portions of the toe pan 24 and seat deck 22 may remain together for the life of the work machine 10, thereby providing an air-tight seal. A similar lock and seal configuration may be used for connecting the seat deck 22 to rear wall portion 28.

Referring to FIG. 6, the multi-piece floor 26 described above allows for the construction of a fully-enclosed rotatable machine cab 12, which aids in isolating the machine cab 12 from outside air, dust and vibrations. The entire machine cab 12 remains together during use of the work machine 10, and maintenance personnel can rotate the entire machine cab 12, including the multi-piece floor 26, out of the way to service the work machine 10.

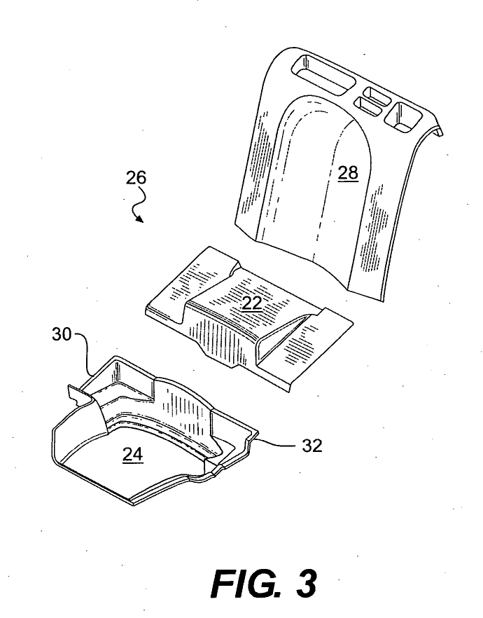

The fully enclosed rotatable machine cab 12 is rotatably mounted to the work body 17 along pivot axis 14 using cab pivot mounts 20 as shown in FIG. 2. The fully enclosed rotatable machine cab 12 may utilize cab lift cylinders 13 to assist in moving the machine cab 12 during upward and rearward rotation as shown in FIG. 3. The lift cylinders 13 may be of any type of lift cylinders, for example, hydraulic or pneumatic lift cylinders, and may be coupled between the work body 17 and machine cab 12 in any manner providing assistance in rotating the machine cab 12.

Alternatively, the fully enclosed rotatable machine cab 12 may by tilted rearward by an operator using a tool such as a detachable hand crank (not shown). The machine cab 12 may be held in place by the lift cylinders 13 or by a conventional self-latching mechanism (not shown). When the machine cab 12 is tilted back, numerous components of the work machine 10 are accessible. For example, the hydraulic pumps, hydraulic motors, engine valve lines and fuel tank may be accessible for quicker, easier service when the machine cab 12 is rotated to its open position.

The multi-piece floor 26 may comprise any appropriate material. For example, the exemplary embodiment shown in FIGS. 2-4, may include injection-molded plastic, which allows for the unique contours included in the individual pieces of the multi-piece floor 26. Alternatively, the multi-piece floor 26 may be formed of sheet metal.

While the exemplary embodiments described above include a three-piece floor, floors having fewer or more individual components are possible. Moreover, while described in conjunction with a fully-enclosed machine cab 12, an alternative embodiment may include a configuration allowing the fully-enclosed rotatable machine cab 12 to have forward rotational movement rather than the rearward rotational movement shown in FIG. 6. This configuration would allow for clearance of the toe pan 24 and have a pivot axis proximate toe pan 24.

### INDUSTRIAL APPLICABILITY

The disclosed multi-piece floor 26 may be applicable to any work machine that includes a machine cab for an operator. The disclosed multi-piece floor 26 may allow better access for maintenance personnel and improved sealing of the machine cab 12. The operation of the multi-piece floor 26 in combination with the machine cab 12 will now be explained.

During operation of work machine 10, the fully enclosed rotatable machine cab 12 is in the closed position as shown in FIG. 1. The operator will sit on a seat mounted to the seat portion 22 and will operate the work machine 10 by controlling, among other things, the work arm assembly 16 and tilt cylinders 15 to control movement of the work tool 18. The operator may also place his or her feet within the toe pan 24 during work operations for safety.

Upon exiting the work machine 10, the operator or other maintenance personnel may access the systems of the work machine by initiating cab lift cylinders 13 causing the fully enclosed rotatable machine cab 12 to rotate in the rearward direction up and away from the work body 17 of the work machine 10. Thus, the systems of the work machine 10 may be accessed for any required repairs or upkeep. Upon completion of repairs or maintenance, the rotatable machine cab 12 is lowered back to its closed position and the operator may continue work operations.

Several advantages over the prior art may be associated with the multi-piece floor 26. The multi-piece floor 26 is attached and movable with the machine cab 12, thus providing access for maintenance personnel allowing for the easy servicing of work machine systems and improved sealing of the cab for heating, air conditioning, and ventilation purposes.

It will be apparent to those skilled in the art that various modifications and variations can be made to the disclosed machine cab. Other embodiments will be apparent to those skilled in the art from consideration of the specification and practice of the disclosed multi-piece floor. It is intended that the specification and examples be considered as exemplary only, with a true scope being indicated by the following claims and their equivalents.

What is claimed is:

1. A machine cab, comprising:
a cab frame;
a front door pivotally connected to the frame;
side panels connected to the frame;
a roof portion connected to the side panels; and
a floor portion connected to the side panels, wherein the floor portion includes a multi-piece floor.

2. The machine cab of claim 1, wherein the multi-piece floor further includes a toe pan, a seat deck disposed proximate the toe pan, and a rear wall portion disposed proximate the seat deck.

3. The machine cab of claim 2, wherein the toe pan extends from the seat deck to beyond a front face of the machine cab.

4. The machine cab of claim 1, wherein the machine cab is configured to be pivotably mounted to a frame of a work machine.

5. The machine cab of claim 2, wherein the cab frame, side panels, roof portion, front door, seat deck, rear wall portion, and toe pan together form an enclosure.

6. The machine cab of claim 1, wherein the multi-piece floor is formed of injection-molded plastic.

7. A work machine comprising:
a work body;
a work tool;
a work arm assembly linking the work tool to the work body;
tilt cylinders disposed proximate the work tool and configured to orient the work tool; and
a rotatably mounted, fully enclosed machine cab disposed adjacent the work body, the machine cab includes a multi-piece floor, wherein the components of the multi-piece floor are configured to lock and seal together and to side panels and a cab frame when assembled.

8. The work machine of claim 7, wherein the machine cab is configured for rearward rotation.

9. The work machine of claim 7, wherein the components of the multi-piece floor include a toe pan, a seat deck disposed proximate the toe pan, and a rear wall portion disposed proximate the seat deck.

10. The work machine of claim 7, wherein the fully enclosed machine cab further includes a front door connected to the cab frame and a roof portion connected to the side panels.

11. The work machine of claim 10, wherein the cab frame, side panels, front door, roof portion, seat deck, rear wall portion, and toe pan form an enclosure.

12. The work machine of claim 10, wherein the toe pan extends from the seat deck to beyond the front of the machine cab.

13. The work machine of claim 10, wherein the toe pan is configured to lock and seal to the seat deck.

14. The work machine of claim 12, wherein the seat deck is configured to lock and seal to the rear wall portion.

15. The work machine of claim 14, wherein the seat deck, rear wall portion and toe pan are formed of injection-molded plastic.

16. The work machine of claim 7, wherein the work machine includes a skid steer loader.

17. A method of manufacturing a machine cab of a work machine, comprising:
providing a machine cab support frame;
providing side panels, a roof portion, and a door portion;
attaching the side panels and the roof portion to the support frame; and
installing a multi-piece floor to the machine cab, wherein the multi-piece floor is attached to the support frame and the side panels to form a fully enclosed machine cab.

18. The method of claim 17, wherein the multi-piece floor is installed as a substantially final step in the manufacture of the machine cab.

19. The method of claim 17, wherein the multi-piece floor includes interlocking floor sections.

20. The method of claim 17, wherein the machine cab is coupled to a skid steer loader work machine.
